(19) United States
(12) Patent Application Publication
(10) Pub. No.: US 2012/0264089 A1
(43) Pub. Date: Oct. 18, 2012

(54) EDUCATIONAL, MONEY MANAGEMENT INTERNET GAME FOR CHILDREN AND MONEYBOX THEREFOR

(76) Inventors: Nguyen Hoan Hoang, Brossard (CA); Jérôme Bousquet, Blainville (CA); Philippe Racine, Longueuil (CA)

(21) Appl. No.: 13/382,661

(22) PCT Filed: Jul. 8, 2010
(86) PCT No.: PCT/CA2010/001089

§ 371 Date: Jul. 2, 2012

Related U.S. Application Data
(60) Provisional application No. 61/213,728, filed on Jul. 8, 2009.

(51) Int. Cl. G09B 19/18

(52) U.S. Cl. 434/107

(57) ABSTRACT

An educational money management game comprises a host platform provider, a remote interface device in communication with the host platform provider and a moneybox in communication with the interface device. The interface device displays interactive game scenes produced by the host platform provider to a user. The moneybox includes a reader for reading the monetary value of coins inserted therein. When the user inserts coins in the moneybox, the monetary value thereof is communicated to the host platform provider and displayed by the interface device to be viewed by the user. The game includes an interactive interface for providing for the user to allot at least a portion of the displayed monetary value to one or more of said allocation options. A network is provided for a plurality of users via the internt using remote interfaces at each user's location. The game scenes produced include a common image displayed by each remote interface. Each interface provides for each user to allot at least a portion of the displayed monetary value to the common image. The common image displays an aggregate value of money corresponding to the total value of each user's portion.

### CROSS-REFERENCE TO RELATED APPLICATIONS

The present application claims priority of U.S. Provisional Patent Application Ser. No. 61/213,728 filed on Jul. 8, 2009 and incorporated herein by reference in its entirety.

### THECHNICAL FIELD

The present invention relates to an educational game for children. More specifically, but not exclusively, the present invention relates to an educational and interactive money management game for children that is played via the internet.

### BACKGROUND

Financial literacy for youth remains a challenge. It has been estimated that disposable income for savings has dropped from almost 10% to about 1% from the early 1970s to the mid 2000s. Furthermore, the majority of young adults have at least one bank account, a credit card, as well as insurance (automobile) and debts (school, automobile etc.). The rate of consumer debt and bankruptcy has risen drastically in the last decade. At least one reason for this may be the lack of financial literacy for youth.

Parents and educators are aware that financial literacy should start at an early age in order for children to internalize proper money management skills that will serve them for the rest of their lives. Parents are not only interested in teaching their children proper savings and purchasing skills but to also teach them community values through socially and environmentally responsible investing, as well as sharing their wealth with others (donations and the like). Parents also want their children to learn that there are benefits (via allowances) for acceptable behavior (household chores for example).

There thus remains the need for an educational tool that provides children with money management skills and that encompasses financial literacy, financial prudence, business awareness, investment literacy, social and environmental responsibility, and community values.

### OBJECTS

An object of the disclosure is to provide a system for an educational money management game using the Internet.

An object of the disclosure is to provide an educational money management video game for at least one user.

An object of the disclosure is to provide an educational money management video game network for a plurality of remote users.

An object of the disclosure is to provide an educational and interactive virtual money management internet game for children.

An object of the disclosure is to provide an interactive virtual money management network for children.

An object of the disclosure is to provide a moneybox device for an interactive virtual money management game.

An object of the disclosure is to provide a tool for parents to teach their children financial literacy that is both prudent and responsible in the form of a virtual money management game.

An object of the disclosure is to provide advertisers to communicate with parents based on their child's behavior within an interactive virtual money management game

### SUMMARY OF ILLUSTRATIVE EMBODIMENTS

In accordance with an aspect of the disclosure, there is provided a system for an educational money management game using the Internet comprising:

a host platform provider for providing the money management game;

at least one remote interface device in communication with said host platform provider, said interface displaying interactive game scenes produced by said host platform provider to a user; and

a moneybox in communication with said interface device and comprising a reader for reading the monetary value of coins inserted therein,

wherein when the user inserts coins in said moneybox, the monetary value thereof is communicated to said host platform provider and displayed by said interface device to be viewed by the user.

In an embodiment, said host platform provider comprises a host server.

In an embodiment, said interface device comprises a computer.

In an embodiment, said reader is removable mountable to a variety of moneyboxes. In an embodiment, said moneybox comprises transparent material, said host platform provider providing the user with a variety of moneybox-insert designs to select from displayed via said interface device.

In an embodiment, said moneybox communicates to said host platform provider the total value of coins therein. In an embodiment, said interface device provides the user with communicating an amount of non-coin funds, said host server providing for adding the value of amount of non-coin funds to the previously communicated monetary value of inserted coins. In an embodiment, said host platform provider produces cartoon images of the types of coins read by said moneybox reader to be displayed by said interface device. In an embodiment, said host platform provider produces cartoon images of the types of non-coin funds communicated via said interface device.

In an embodiment, the money management game comprises providing the user with the option of allotting at least portions of the monetary value to predetermined money allocation options. In an embodiment, the host platform provider provides for different money allocation options to be displayed via said interface device to the user, said interface display device providing the user with communicating allocation options. In an embodiment, said host server provides for displaying an allocation interactive scene providing the user to allocate portions of the monetary value into different sections. In an embodiment, said different sections comprise at least one spend section and/or at least one save section and/or at least one invest section and/or at least one share section and/or at least one goal section. In an embodiment, said goal section comprises a predetermined monetary value to be progressively allotted thereto by the user. In an embodiment, said host provider produces a progress message displayed by said interface device indicating the amount of money allotted to the goal section and the amount of money left to allot so as to reach said predetermined monetary value. In an embodiment, said interface device provides for communicating to said host platform provider that a desired portion of the monetary value be allotted to a given said section. In an embodiment, said host platform provider provides pre-determined ratios of the monetary value to be allotted to given said sections. In an embodiment, said interface device provides for communicating to said host platform provider a desired modification of said pre-determined ratios.

In an embodiment, said host platform provider attributes virtual money in relation to communication entries provided by the user via said interface device. In an embodiment, the system further comprises an additional interface device in communication with said host platform provider. In an embodiment, said virtual monetary units are produced by said host platform provider in response to entries communicated via said additional interface device.

In an embodiment, the system further comprises an additional interface device providing for communicating with said host platform provider so as to modulate the interactive game scenes produced by said host platform provider.

In an embodiment, the system further comprises a plurality of remote interface devices in communication with said host platform provider for a corresponding plurality of users. In an embodiment, said host platform provider produces a common interactive image displayed by each said remote interface device. In an embodiment, said common interactive image provides for displaying an aggregate value of money corresponding to the total value of at least a portion of said monetary value displayed by each said remote interface device to each user.

In an embodiment, said moneybox comprises an identification code communicated to said host platform provider when linked to said interface device. In an embodiment, said moneybox reader comprises said identification code. In an embodiment, said host platform provider modulates said interactive game scenes in response to said identification code. In an embodiment, the system further comprises a third party server in communication with said host platform provider, said third party server communicating information to the user via said interface device in response to said identification code. In an embodiment, said third party server modulates the information sent to said host platform provider to be displayed via said interface device in accordance with said allocation options communicated by the user. In an embodiment, said host platform provider modulates transmission to said interface device of the information received from said third party server to in accordance with said allocation options communicated by the user.

In an embodiment, said host platform provider comprises a memory, said allocation options being stored in said memory.

In an embodiment, the system further comprises a hand held unit comprising an additional interface.

In accordance with an aspect of the disclosure, there is provided an educational money management video game for at least one user comprising:

a moneybox for providing the user to insert coins therein and comprising a reader for reading the monetary value of inserted coins; and

an interface for displaying interactive scenes to the user, said interface communicating with said moneybox so as to display the monetary value of the coins therein, said interface displaying different money allocation options

wherein said interface provides for the user to allot at least a portion of said displayed monetary value to one or more of said allocation options.

In an embodiment, allocation options comprise different section images displayed by said interface. In an embodiment, said different section images comprise at least one spend section image and/or at least one save section image and/or at least one invest section image and/or at least one share section image at least one goal section image. In an embodiment, said spend section image displays a variety of virtual products for purchasing comprising virtual prices. In an embodiment, said save section image displays a potential amount of money to be saved. In an embodiment, said at least one share section image comprises a plurality of charity images for the user to select from. In an embodiment, said goal section comprises a predetermined monetary value to be progressively allotted thereto by the user. In an embodiment, said interface displays a progress message displayed by said device indicating the amount of money allotted to the goal section and the amount of money left to allot so as to reach said predetermined monetary value. In an embodiment, said interface provides the user with selecting a desired portion of the monetary value be allotted to a given said section image. In an embodiment, said selected desired portion is displayed by said interface and associated to a selected section image. In an embodiment, the video game further comprises pre-determined ratios of the monetary value to be allotted to given said section images. In an embodiment, said pre-determined ratios are modifiable.

In an embodiment, the video game further comprises a behavior monitor for monitoring the economic behavior of the user, said economic behavior of the user comprising said allotment options selected by the user and the portions of said monetary value allotted to each said allotment option. In an embodiment, said behavior monitor attributes a score based on said economic behavior. In an embodiment, said behavior monitor attributes virtual money based on said economic behavior. In an embodiment, said behavior monitor comprises a plurality of parameters for attributing a given said score to a given said economic behavior. In an embodiment, said behavior monitor comprises a plurality of parameters for attributing a given amount of said virtual money to a given said economic behavior. In an embodiment, said interface allows the user to modulate said plurality of parameters.

In accordance with an aspect of the disclosure, there is provided an educational money management video game network for a plurality of remote users, said video game network comprising:

a host platform provider; and

a plurality of remote interfaces in communication with said host platform provider, each said interface associated to a respective remoter user for displaying interactive game scenes produced by said host platform provider to the respective user, said game scenes comprising a common image displayed by each one of said plurality of remote interfaces; and

a plurality of moneyboxes, each one of said moneyboxes associated with a respective remote given user and being in communication with said interface associated with the respective user, each said moneybox comprising a reader for reading the monetary value of coins inserted therein,

wherein each said interface provides for each user to allot at least a portion of said displayed monetary value to said common image, said common image displaying an aggregate value of money corresponding to the total value of each said at least a portion of said monetary value.

In an embodiment, a game environment is provided that includes an interface linked to a moneybox and a platform provider. The interface is used by a child who places money into the moneybox and this information is sent to the platform. The platform provider produces interactive scenarios by way of interactive scenes or images that are illustrated via the interface based on the amount of money. In one embodiment, the money is divided into portions allotted for spending, sharing and investing. The child can set savings goals in order to accumulate funds so as to purchase a product. The child may share some of their money with charities or foundations. The child may also invest their money. Points may be allotted to the child based on their behavior within the various game scenarios or events.

In another embodiment, there is provided a game network environment comprising a plurality of interfaces respectively being used by separate children, each interface is linked to its respective moneybox and all the interfaces are linked together to a common platform provider. The children within the game network environment can communicate with each other to buy and sell virtual products, to fundraise, and to trade virtual investments.

In an embodiment, a game environment is provided that includes a children's interface linked to a moneybox and a platform provider, a parents' interface monitor that configures the children's interface thereby configuring the game played by the child.

In an embodiment, a game environment is provided that includes a children's interface linked to a moneybox and a platform provider, a parents' interface that monitors and configures the children's interface thereby configuring the game played by the child, a third party server is linked to the platform to provide data to the parents based on their child's behavior within the game.

Other objects, advantages and features of the present invention will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a block diagram of a basic game environment in accordance with a non-restrictive illustrative embodiment of the present invention;

FIG. 2 is a perspective view of a remote device and a moneybox device in accordance with a non-restrictive illustrative embodiment of the present invention;

FIG. 3 is a perspective view of various typed of moneybox devices in accordance with a non-restrictive illustrative embodiment of the present invention;

FIGS. 4A to 4C show the children's interactive interfaces of the game in accordance with a non-restrictive illustrative embodiment of the present invention;

FIG. 5 shows the Village interface of the game in accordance with another non-restrictive illustrative embodiment of the present invention;

FIG. 6 shows the web page icons of the Village interface of FIG. 5;

FIG. 7 shows the tool icons of the Village interface of FIG. 5;

FIG. 8 shows a Moneybox interface of the game in accordance with a non-restrictive illustrative embodiment of the present invention;

FIGS. 9A and 9B show a House interface of the game in accordance with a non-restrictive illustrative embodiment of the present invention;

FIG. 10 shows an Allocation Wheel interface of the game in accordance with a non-restrictive illustrative embodiment of the present invention;

FIG. 11A shows a Park interface of the game in accordance with a non-restrictive illustrative embodiment of the present invention;

FIG. 11B shows Kiosk interface of the game in accordance with a non-restrictive illustrative embodiment of the present invention;

FIG. 12 shows a Commercial Street interface of the game in accordance with a non-restrictive illustrative embodiment of the present invention;

FIGS. 13A-13D show a Bank interface of the game in accordance with a non-restrictive illustrative embodiment of the present invention;

FIG. 14 is a block diagram of a children's interactive network of the game of the game in accordance with a non-restrictive illustrative embodiment of the present invention;

FIG. 15 is a block diagram of the interfaces of the children's interactive network of FIG. 14;

FIG. 16 is a block diagram of the game environment in accordance with another non-restrictive illustrative embodiment of the present invention;

FIG. 17 is a block diagram of the parents' interfaces of the game environment of FIG. 16;

FIG. 18 is a block diagram of a game environment in accordance with a further non-restrictive illustrative embodiment of the present invention

FIG. 19 is a block diagram of a game environment in accordance with still a further non-restrictive illustrative embodiment of the present invention; and

FIG. 20 is a perspective view of moneybox in accordance with a non-restrictive illustrative embodiment of the present invention.

### DETAILED DESCRIPTION OF ILLUSTRATIVE EMBODIMENTS

Generally stated, there is provided an educational money management game that comprises a host platform provider, a remote interface device in communication with the host platform provider and a moneybox in communication with the interface device. The interface device displays interactive game scenes produced by the host platform provider to a user. The moneybox includes a reader for reading the monetary value of coins inserted therein. When the user inserts coins in the moneybox, the monetary value thereof is communicated to the host platform provider and displayed by the interface device to be viewed by the user. The game includes an interactive interface for providing for the user to allot at least a portion of the displayed monetary value to one or more of said allocation options. A network is provided for a plurality of users via the internet using remote interfaces at each user's location. The game scenes produced include a common image displayed by each remote interface. Each interface provides for each user to allot at least a portion of the displayed monetary value to the common image. The common image displays an aggregate value of money corresponding to the total value of each user's portion.

With reference to the appended drawings, non-restrictive illustrative embodiments of the present invention will be described herein so as to exemplify the invention and not limit the scope thereof.

### Basic Game Environment

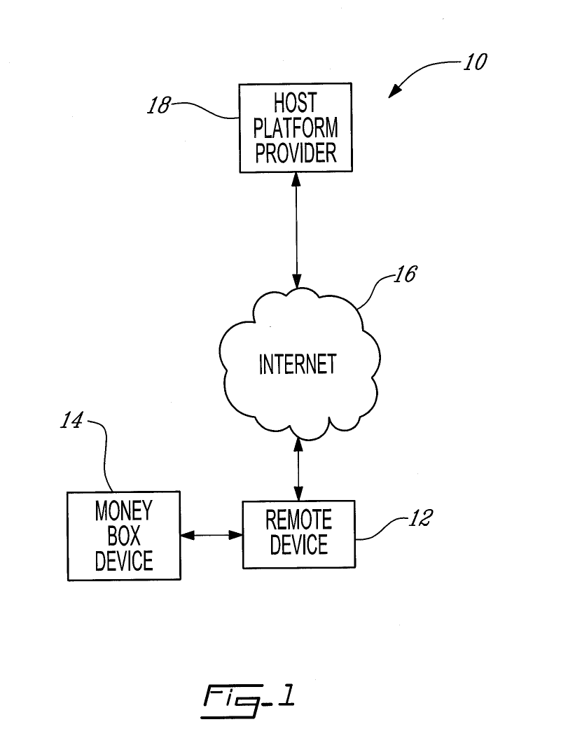

FIG. 1 shows a block diagram illustrating a game environment or system 10 comprising a remote interface device 12 linked to a moneybox device 14 and also linked via the internet 16 to a host platform provider 18 for providing data thereto. As shown in FIG. 2, the remote device 12 can be a PC computer for example that the user interfaces with as will be explained below. The host platform provider 18 provides an interactive game platform including scenes and scenarios that is displayed on the remote computer 12.

### The Moneybox

As better shown in FIG. 2, the moneybox device 14 comprises a reader 20 and a container 22. The reader 20 comprises a slot 24 for receiving coins 26 therethrough that are dropped within container 22 similarly to a conventional piggy bank. The reader 20 is capable of reading the value of the coins 26 and sending this data the computer 12, this information is then transmitted to the host platform provider 18 which provides a money management game scenario to the user related the amount of money that is entered into their moneybox device 14. In the event that the user wishes to enter paper money (i.e. bills) rather than coins, the reader 20 may be configured to read bills as well. Alternatively, the user manually enters the total amount of money via their computer 12. The foregoing is convenient when the user wishes to enter an amount of money that is provided by check.

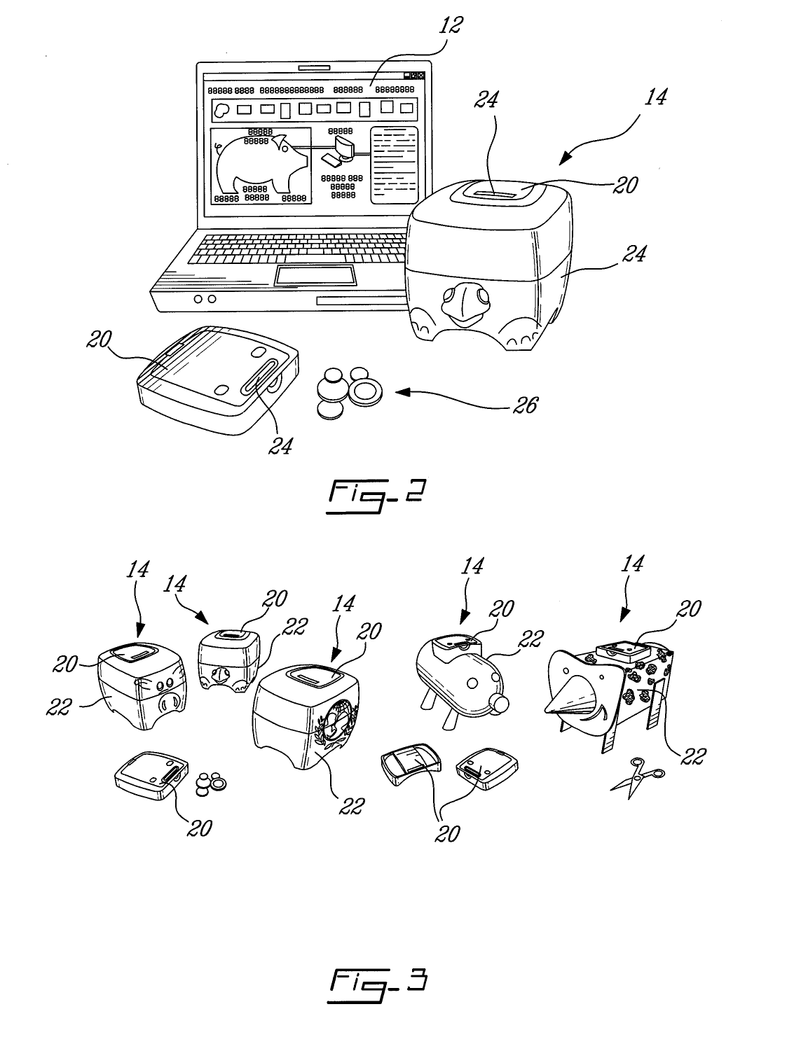

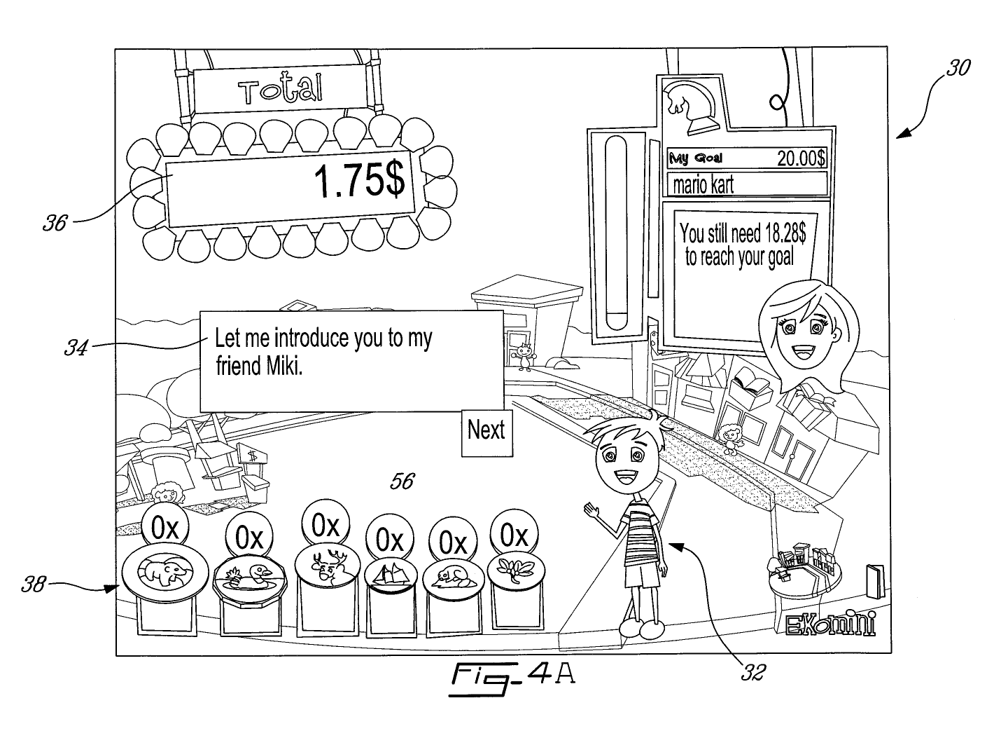

As shown in FIG. 3, a variety of readers 20 can be matched with a variety of containers 22 to produce customized moneybox devices 14.

The user is provided with software related to the game. The reader 20 is linked to the computer 12, (via a USB port for example). The software provides for receiving data from the host platform provider 18. In an embodiment, the reader 20 may be provided with an identification code which is transmitted to the host platform provider 18. This identification code may include the name if the establishment from which the reader 20 was purchased, the geographic territory in which the reader 20 was purchased and the like. A program or software tool is provided that allows the host platform provider 18 to receive information from the moneybox device 14. In this way, the host platform provider 18 may provide an interactive platform more suitable to the user's geographic territory, language, and culture. Furthermore, the establishment from which the reader 20 was purchased can be provided with information from the host platform provider 18 related to the money management behavior or interests of the particular user using that given reader 20. Moreover, this establishment may be able to provide the user with data.

In one embodiment, a program or software tool is provided between the moneybox device 14 and the remote device 12, to permit the remote device to read the counter of the moneybox device 14 (which in this case is the reader 20).

It should be noted that the counter device or reader 20 will count coins and store this data in its permanent memory. As such, the moneybox device 14 does not need to be connected to the platform provider 18 or the computer 14 for the reader 20 to count. The coin count data will remain in the permanent memory of the reader 20 until it is either cleared by the computer 12 or the container is opened. A provisional circuitry detects if the container 22 is opened and if so, the coin count data is cleared and the computer 12 will be informed of it when linked to the moneybox device 14, in which case the host provider 18 sends an email to the parents of the user to inform them that the moneybox device 14 was opened.

### The Children's Interactive Interface

Having now described the basic game environment and the moneybox related to the game, the interactive platform provided to the child user will now be described. It should be noted herein that the expression interactive platform comprises the memory or databank of the platform as well as the various interfaces provided thereby in the form of web pages and dynamic sub-images.

When the host platform provider 18 is linked to the user's computer 12 and reader 20, an interactive platform having a variety of interactive interfaces or web pages is provided. More particularly, the host platform provider 18 identifies the identification code of the reader 20 and compares it to its databank to see if in fact the user of that particular identification code has registered.

In one embodiment, for each user, the following information is stored:
the name, birthday, location and e-mail of the user;
the name and e-mail of the user's parents;
the reader 18 identification code;
the date that the user registered onto the online interactive interface;
the date of the last time the user was online;
an update of the user's account as well as details (coins, checks, paper money etc.) related thereto and the date that each monetary unit was entered into the moneybox device 14 or otherwise accounted for and an update of the allocation of of money saved, as well as money put aside to spend, share, or invest;
the user's allowance (if any);
the user's goals (present, past, future and progress)
user's browsing history within the interactive platform
the user's overall score.

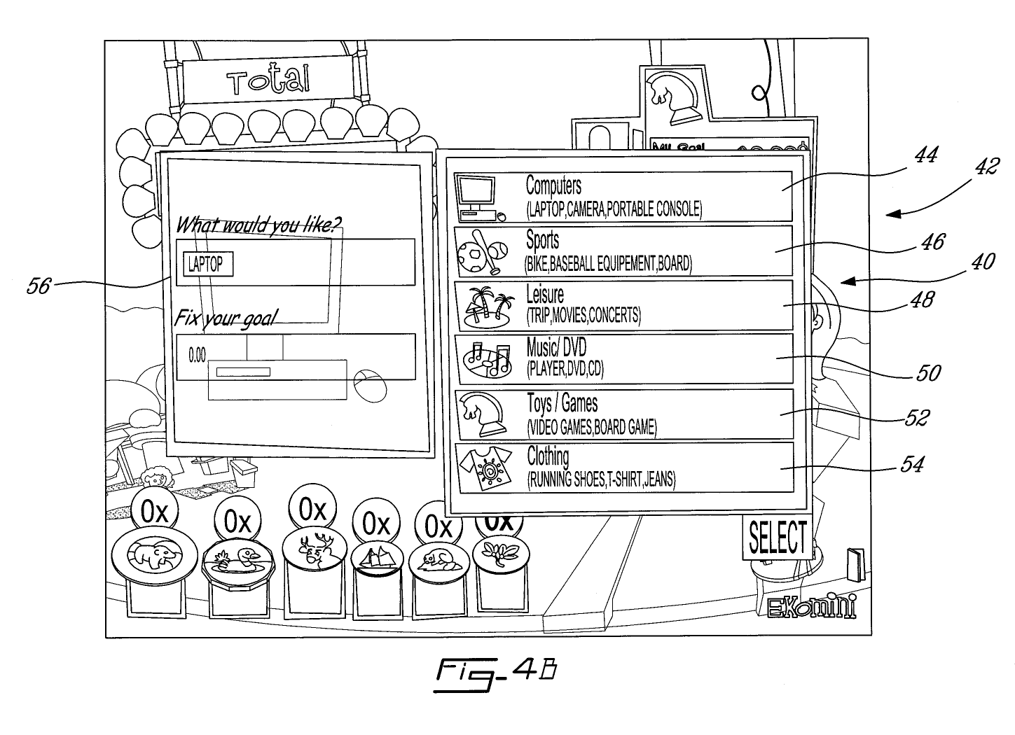

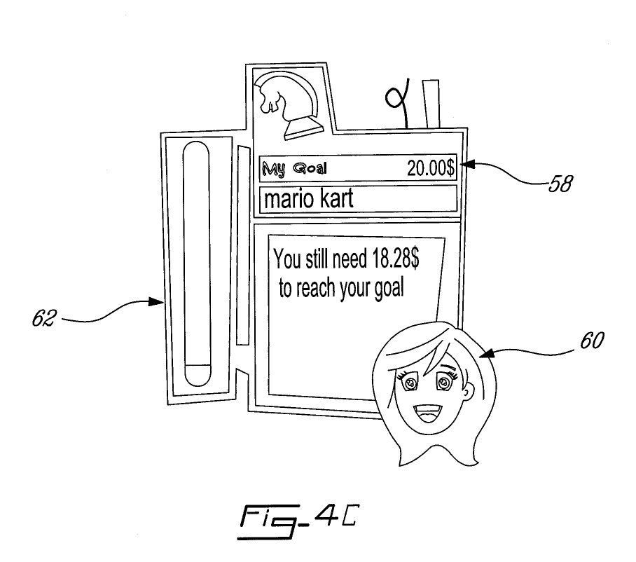

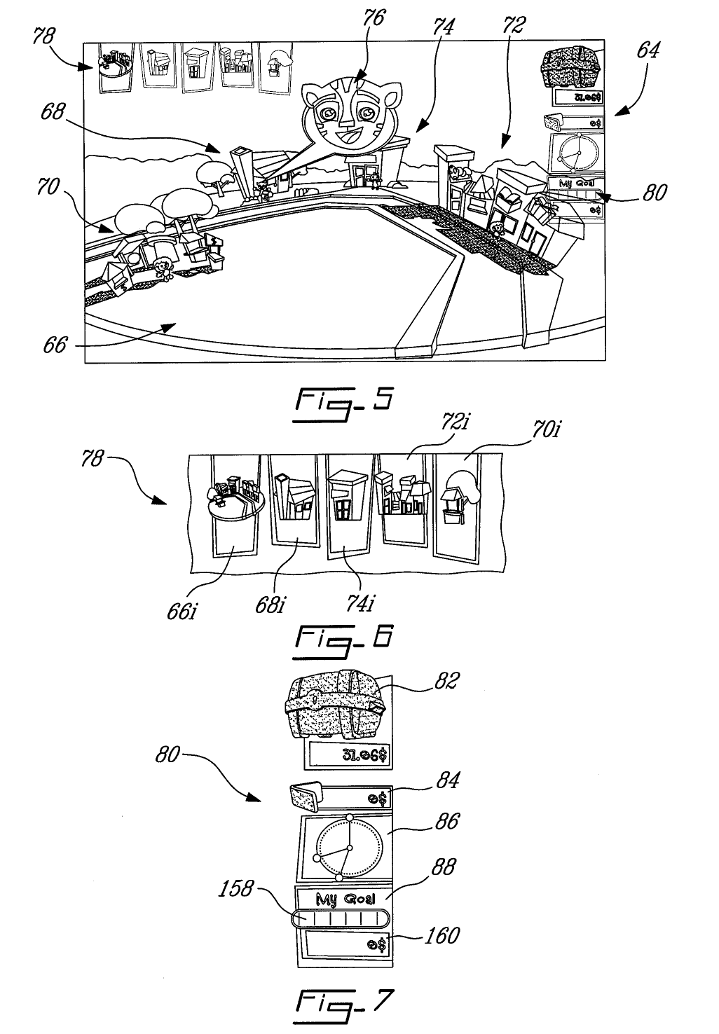

Turning now to FIGS. 4A, 4B and 4C, a first embodiment of the initial interface 30 will be described.

In the basic interface or web page 30, a cartoon character 32 asks questions in a dynamic box 34 that the user can respond into. Usually registration or identification of a registered user can be performed at this stage. The cartoon character 32 then provides the user with their updated virtual account “Total” 36 as well as an image representation 38 of the types of coins 26 in their moneybox device 14. A menu 40 appears on the next web page 42 (FIG. 4A) providing the user with a series of possible purchasing categories: Computers 44, Sports 46, Leisure 48, Music/DVDs 50, Toys/Games 52 and Clothing 54. Each category contains related products. The user can either click on a certain product or write the name of their product down in a dynamic box 56. The total price is set as an objective “My Goal” 58 (see FIG. 4C), with a cartoon character 60 telling the user how much money is still needed to achieve their goal. This is also represented in a barometer image 62.

FIG. 5 shows another embodiment of an initial interactive interface 64 provided by the host platform provider 18.

The initial interactive interface or web page 64 shows a Village image 66 including sub-images of a House 68, a Park 70, a Commercial Street 72 and a Bank 74. These images can be dynamic and a cartoon character 76 can be used as a mouse pointer or cursor to navigate within the Village image 66 and click on a given dynamic sub-image 68, 70, 72, and 74.

Alternatively or concurrently, a group 78 of icons is provided. As shown in FIG. 6, the icon group 78 includes a House Icon 68i, a Park Icon 70i, a Commercial Street Icon 72i and a Bank icon 74i as well as a Village Icon 66i for returning to the original Village image 66.

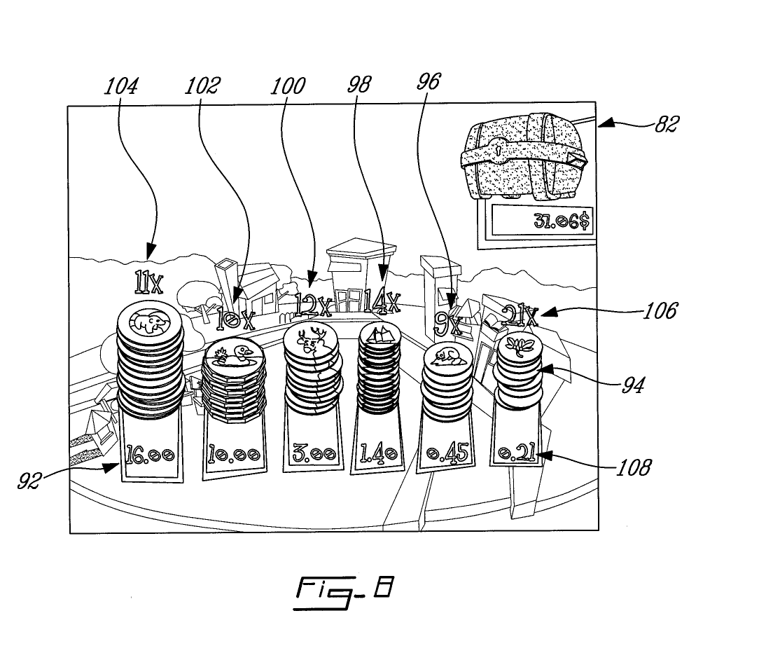

In one embodiment, the initial Village image 66 also includes tool icons 80. As shown in FIG. 7, the tool icons 80 include a Moneybox Icon 82, a Wallet Icon 84, an Allocation Wheel Icon 86 and a Goal Icon 88.

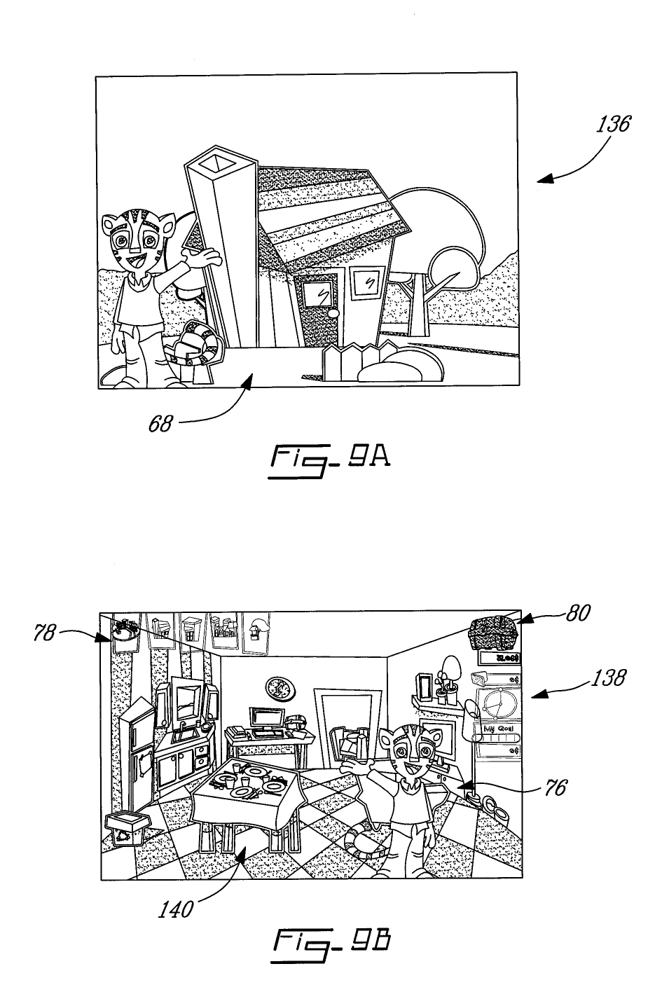

Clicking on the Moneybox Icon 82 opens a Moneybox web page 90, as shown in FIG. 8, including an image 92 of the user's coins 26 divided into images of pennies 94, nickels 96, dimes 98, quarters 100 and the like. Of course, if the game is played in Canada, the web page image 90 includes images of Canadian loonies 102 and twonies 104. The images of the coins is provided in accordance with their actual Country currency (the example of FIG. 8 shows coins in Canadian currency). Each image 94, 96, 98, 100, 102 and 104 shows the number of coins 106 as well as the total amount of a given coin 108. A box 110 shows the total amount of money in the moneybox device 14. With respect to paper bills, in one embodiment, these bills can be stacked in a single bundle image or in separate bills according to their value. In still another embodiment only the money value of paper bills is shown. In the latter case the money value of checks may also be included.

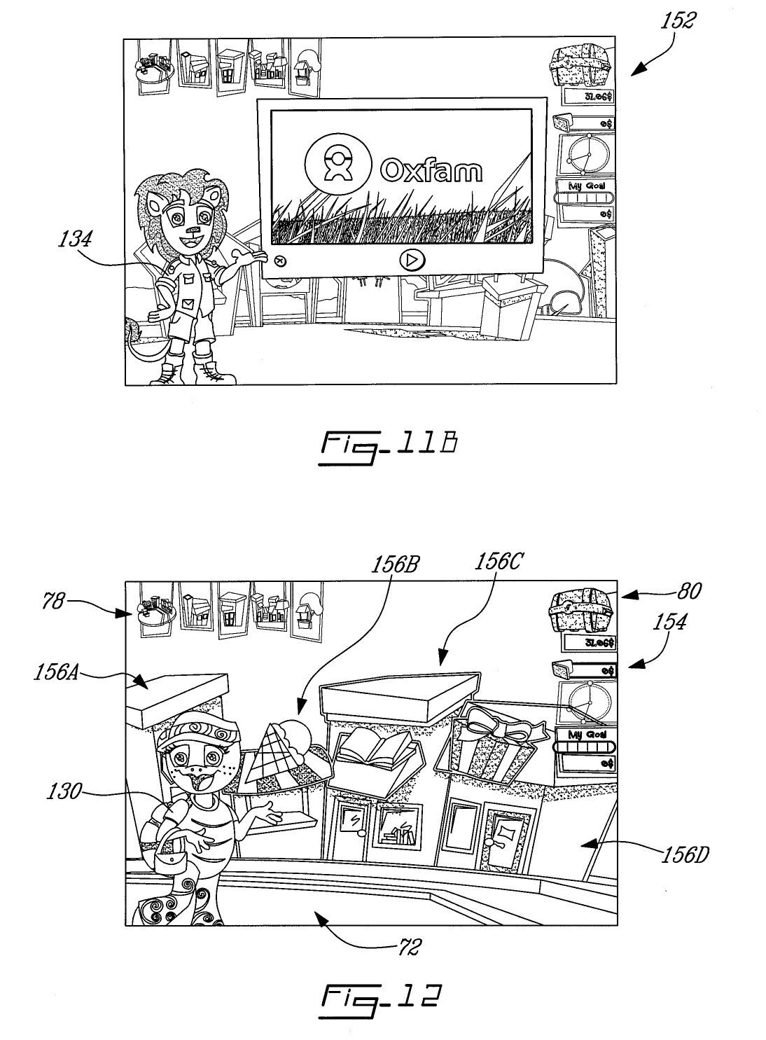

Clicking on the Allocation Wheel Icon 86 opens a web page 112, shown in FIG. 10. The cartoon character 76 explains to the user that an Allocation Wheel Image 116 provides a suggested money allotment scheme. In the example shown here, the Allocation Wheel Image 116 is divided into three sections: Spend 118, Invest 120 and Share 122. The sections 118, 120 and 122 represent a percentage of the user's money that will be allotted for spending, investing and sharing (i.e. donations and the like). In the illustrated example, 55% of the user's money is allotted for spending, 30% for investing and 15% for sharing. In another example, the allotment may be 70% for spending, 20% for investing and 10% for sharing. Of course, the user can modify this allotment scheme. Next to each section 118, 120 and 122 is a respective box, 124, 126 and 128 showing the total amount of money allotted for spending, investing and sharing, respectively. Cartoon characters 130, 132 and 134, respectively related to the spending, investing and sharing scenarios throughout the game are respectively positioned next to the Spend 118, Invest 120 and Share 122 sections of the Allocation Wheel Image 116, thereby allowing the child user to better or more clearly understand the significance of each foregoing section.

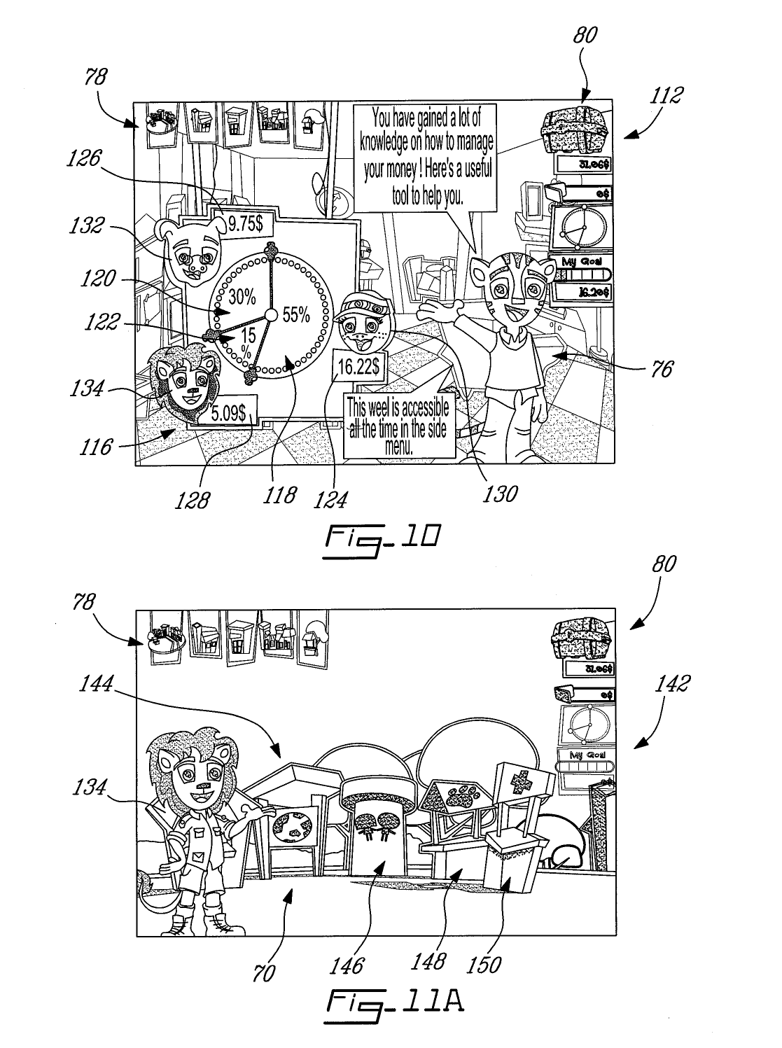

When clicking on the House icon 68i or on the Home Image 68 on web page 64, a House interface or web page 136, as shown in FIG. 9A, is opened. Web page 136 illustrates an introductory enlarged House Image 68, leading to interface or web page 138, shown in FIG. 9B, which illustrates an Inside House Image 140. The cartoon character 76 provides information related to web page 138. In web page 138, the user may be provided with a virtual allowance. In one non-limiting example, this virtual weekly allowance can be equal to the age of the user multiplied by a virtual 1$. The foregoing can be modified by the user and other parameters can be set for providing a virtual allowance. As such, the user can accumulate virtual money as well as real money. In an embodiment, the web page 138 provides for opening the web page 112 previously described or for including the Allocation Wheel Image 116 which can be reviewed and reassessed. In one embodiment, the House web page 138 contains all the registration information as well as the various parameters that have been set throughout the game.

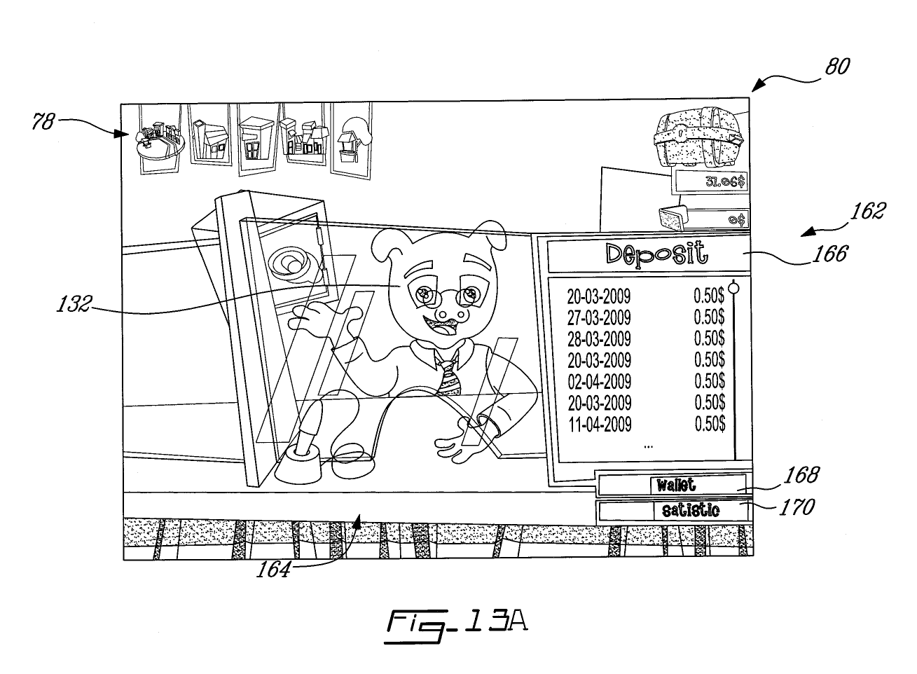

When clicking on the Park icon 70i or on the Park Image 70 on web page 64, a Park interface or web page 142, as shown in FIG. 11A, is opened, showing an enlarged Park Image 70 and including the cartoon character 134. The cartoon character 134 explains to the user that they can donate or share some of their money with others who need it and a variety of cartoon kiosk images representing charities, foundations and the like are illustrated. In this example, the Park Image 70 includes an Ecology Kiosk Image 144, a Childhood Kiosk Image 146, an Animals Kiosk Image 148, and a Health Kiosk Image 150. Each of the Kiosk Images 144, 146, 148 and 150 is dynamic and when clicking on one of the images a new web page is opened related to the foundation or charity in question. In an embodiment, a list of charities or foundations related to the theme of each Kiosk is provided and when clicking on one of the listed charities within a particular Kiosk category or theme, a new web page 152, as shown in FIG. 11B, is opened. In an embodiment, the kiosk web page 152 includes the name and country of origin of the charity or foundation, a description, the number of adherents, an explanatory video and the like. The user can then allocate some of their money to the foundation or charity of their choice.

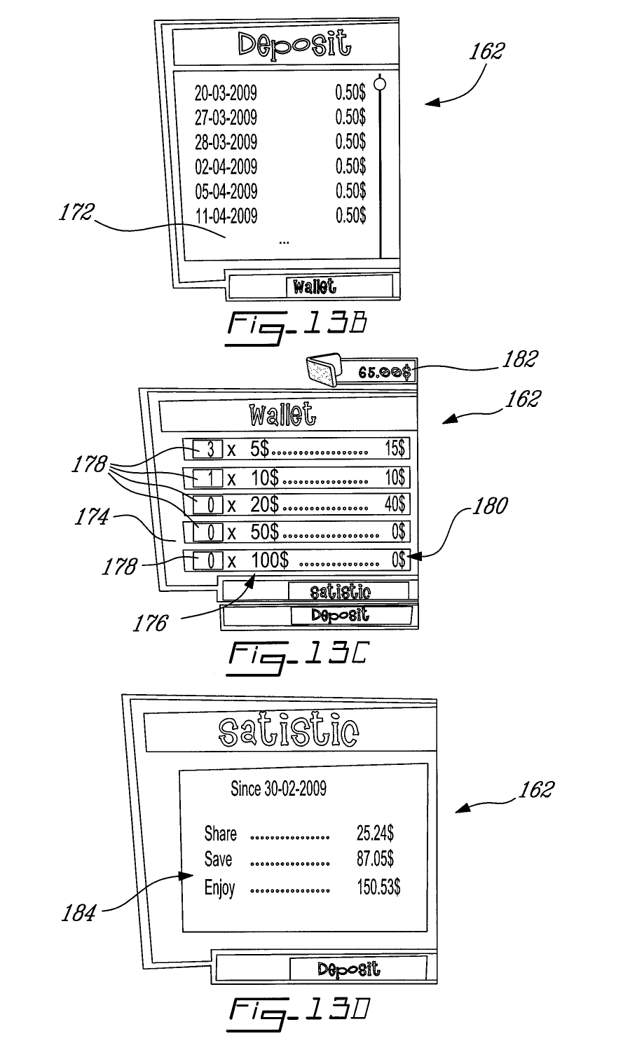

When clicking on the Commercial Street icon 72i or on the Commercial Street Image 72 on web page 64, a Commercial Street interface or web page 154, as shown in FIG. 12, is opened, showing an enlarged Commercial Street Image 72 and including the cartoon character 130. The web page 154 includes a variety of purchasing categories similar to those described above with respect to the embodiment described in FIGS. 4A-4C. In the embodiment of web page 154, the purchasing categories are illustrated in the form of dynamic cartoon store images 156A, 156B, 156C and 156D with each store relating to a given category. Once the user clicks on a give dynamic cartoon image of a store 156A, 156B, 156C and 156D, a new web page opens showing the inside of the store. The store web page includes cartoon images of types of products.

For example if the user clicked on a Toy/Game Store image, the new web page would show various types of products in dynamic images of aisles for example, such as Video Games, Board Games, and Toys. The Stores are of course tailored to the age of the user. If the user clicks on the Video Game aisle, a new Aisle web page opens showing the user specific products. In another embodiment, the Aisle will be divided into still other subgroups. The user may select one or more products within a given category or various categories and the sub-groups thereof as the skilled artisan will readily contemplate. Once the products are selected, they are registered by the platform databank and kept in memory.

Turning back to FIG. 7, the My Goal icon 88 shows the user's progress (accumulated money or saved money) in comparison to the amount they need in order to achieve their goal (purchase price of product selected). When clicking icon 88, the icon image 88 is either enlarged or a new web page opens showing more details with respect to the user's progress in terms of achieving their goal.

A Barometer Image 158 is provided for each product showing progress of the user in relation to the amount they need to accumulate. A box 160 shows the total amount the value or price of the product, the Barometer Image 158 fills up in accordance with the amount of money that has been saved by the user. In an embodiment, a Cumulative Barometer can also show the cumulative goal (monetary value) of all the items selected by the user and show their overall progress. The cartoon character 130 can also tell the user the estimated time that they will reach their goal: by flashing a statement like: You will reach your objective in 10 weeks to give but one example. This time estimate is based on the amount that the user saves per day. The platform tracks the user's saving behavior and an algorithm calculates the user's estimate time to save a given amount.

Throughout the game, the user may change their objective and reassess their goals. Of course, every change and modification is tracked and kept in memory by the host platform provider 18.

In an embodiment, when the user clicks on a purchase category and product images are produced, the words Desire and Need are produced next to each product. The user must then decide if each of the products shown should fall under the category Need or Desire. Virtual money is attributed to the user for getting correct answers.

When clicking on the Bank icon 74i or on the Bank Image 74 on web page 64, a Bank interface or web page 162, as shown in FIG. 13A, is opened, showing a Bank Environment Image 164 and including the cartoon character 132. The web page 162 includes the following menu tabs: Deposit 166, Wallet 168, and Statistic 170.

The Deposit menu 166 generates a Deposit Image 172, shown in FIG. 13B, that includes a list of every deposit (date and amount) in the moneybox device 14.

The Wallet menu 168 generates a Wallet Image 174, shown in FIG. 13C, showing the user how to insert or remove bills. A list 176 of paper bill values is provided (ex: 1$, 5$, 10$, 20$, 100$ etc.). Next to each paper bill value is a dynamic Box 178 in which the user can write the amount of a given bill that they wish to include within the moneybox device 14. Once the number of a certain paper bill has been added in box 178, the Image 176 includes a list 180 of the total monetary value per each paper bill of the list 176. The grand total of all the paper bills is added in a Grand Total Box 182 and shown to the user. The user may also have access to the Wallet Image via the tool icon 82 previously described.

The Statistic menu 170 generates a Statistic Image 184, shown in FIG. 13D that includes the following headings Since 186, Share 188, Save 190 and Enjoy 192. The Since heading 186 refers to the date of the first connection onto the platform. The Share heading 188 refers to the amount of money shared or otherwise donated. The Save heading 190 refers to the amount of accessible money in the moneybox device 14. The Save heading 190 can also include the money that has been set aside to purchase a product (i.e. the money under the My Goal icon 88) as well as money that has been invested. In another embodiment, the menu 170 provides an Invest heading with details related thereto. The Enjoy heading 192 refers to the amount of money spent and in another embodiment, it refers to the amount of money put aside to spend and in still another embodiment it refers to both. The Statistic menu can also include details related to the virtual money acquired throughout the game.

In another embodiment, the cartoon character 132 may also provide investment information to the user and the user may invest within a certain Investment Product and follow the virtual growth in interest or loss. The Investment Product may allocate dividends in virtual money. Losses of course will be based on the virtual money accumulated. The user is provided with information related to each Investment Product and they may also receive updates (in a window on the platform interface or via e-mail) on the performance of their Investment Product as well as new potential Investment Products. As such, the user may build a Virtual Investment Portfolio based on Virtual Stocks, Virtual Mutual Funds, and Virtual Bonds that can be bought and sold.

The virtual money accumulated throughout the platform provides a score to the user. The platform can also provide a score review page in order to help the user understand where they went wrong within the game and provide advice or commend them on good choices. As such, the user can review their performance and learn better money management techniques.

In another embodiment, the money that falls under the Invest heading of the game is money that remains within the moneybox device 14. This money may be placed in a virtual investment that accrues interest. Parents may wish to remunerate this interest via the parent's interface described below.

As for virtual money or game points, it is within the context of the invention, to allot these moneys or points based on various events, games, questions within the overall children's interactive platform. In one embodiment, gifts, such as promotional t-shirts, toys or objects can be attributed to uses based on their points or virtual money score.

### The Children's Interactive Network

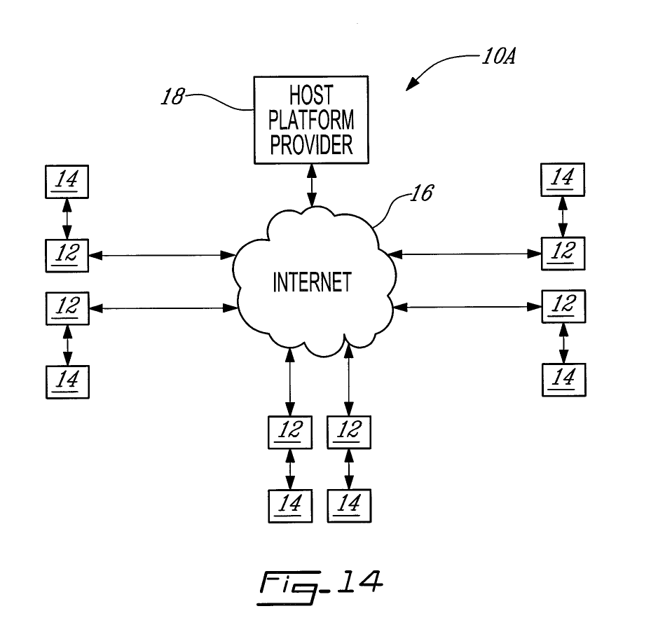

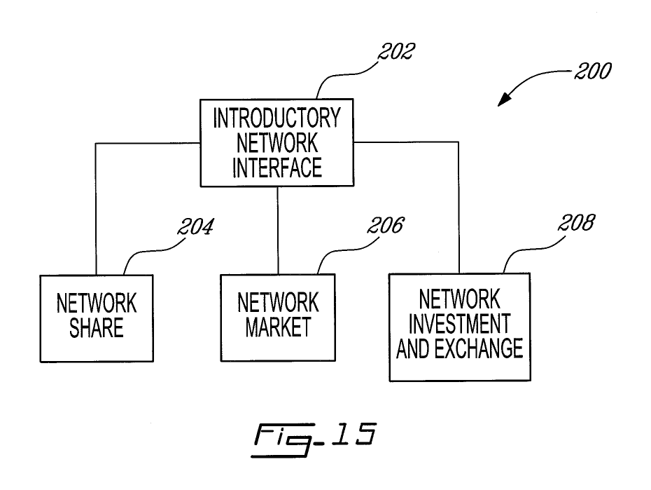

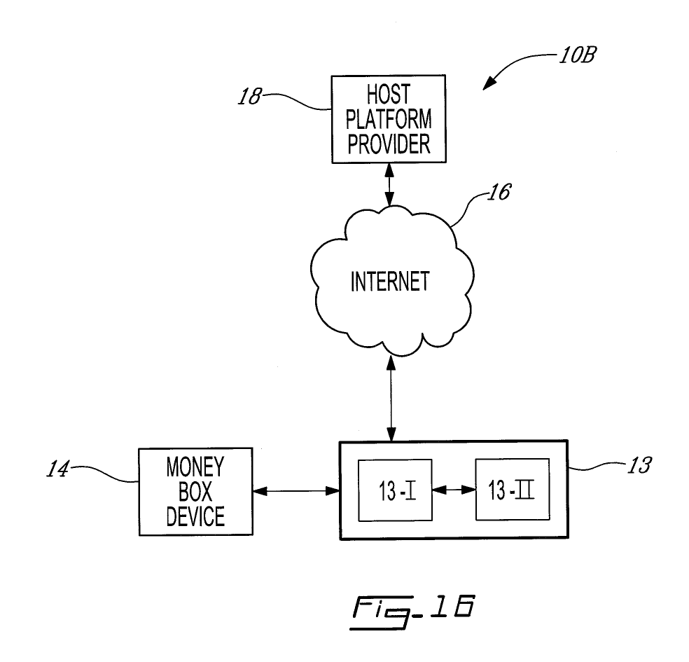

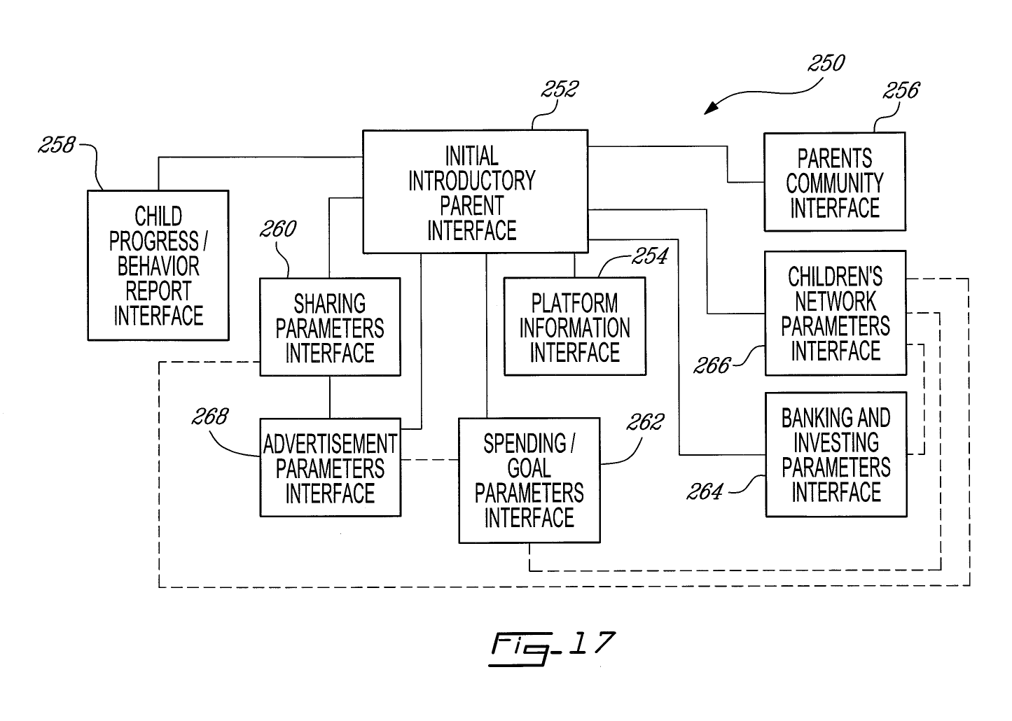

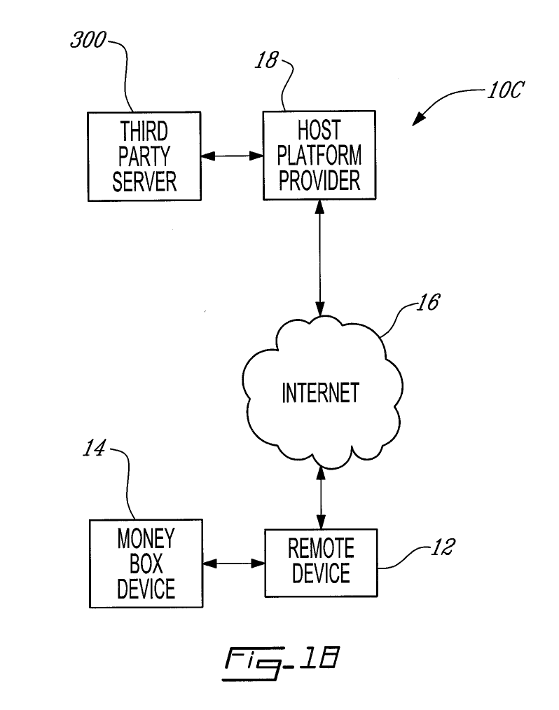

FIG. 14 shows another game environment, in the form of a network 10A including a plurality of remote devices 12 in remote locations, linked to respective moneybox devices 14, and to the host platform provider 18 via the internet 16.

In this way the various users in remote locations can interact via the game network 10A.

As such, other interfaces or web pages can be provided related to the game network 10A.

FIG. 15 shows the block diagram 200 representing various interactive interfaces of the network 10A. An introductory network interface 202 can provide information related to using the interactive networking options of the game. In this example, there are three networking options provided by three interfaces or web pages, namely a Network Share interface 204, a Network Market Interface 206 and a Network Investment and Exchange Interface 208.

The Network Share Interface 204 provides for allowing users to set up a charity or a foundation that other users can donate to. Hence, users can fundraise and also share information regarding existing charities.

The Network Market Interface 206 provides for users to sell virtual products within the game and other users can purchase these products. Users can provide information related to the product and adjust the price based on demand.

The Network Investment and Exchange Interface 208 provides users for selling and buying virtual shares from one another and sharing information regarding investments and the like.

### The Parents' Interactive Interface

FIG. 16 shows a game environment 10B including a remote device 13. The remote device 13 may comprise two networked or linked devices 13-I and 13-II or a single device, linked to a moneybox device 14 and to the host platform provider 18 via the internet 16. The same remote device 13 can be used by the child user and their parent. Alternatively, the child user uses its own remote device 13-I that is linked to the remote device 13-II of the parent which may be in the same location or a remote location.

In game environment 10B, the parent can select certain parameters with respect to the game, so that the child user plays the game within those parameters. The parent can also be provided with a progress report, the navigation history as well as the money management behavior of the child and the like.

FIG. 17 shows a block diagram 250 representing various interactive interfaces of the environment 10B. An Initial Introductory Parent Interface 252 provides for explaining to the parent the various features of the game as well as the various parameters they can control or modulate. The registration information can be provided by Interface 252. Interface 252 provides for generating the subsequent interfaces or dynamic web pages described hereinbelow.

A Platform Information Interface 254 provides the parent with relevant data and updates as well as world news information and educative hints and tools. The parent can also discuss and interact with other parents via a Parents' Community Interface 256, which can be provided in the form of a blog or forum. Sub-communities can be created depending on the location and age range of the children. The parent receives information on the child's progress and money management behavior from a Child Progress/Behavior Report Interface 258. The interface 258 can provide the parent with tools to configure the children's interactive interface. For example, the parent may configure the budget allocation of the child user and provide different percentages related to the child's allotment for spending, saving, investing and sharing. The parent may choose certain specific games that the child will have access to in order to emphasize certain skills or behaviors. As such, the Information and Community Interfaces 254 and 256 are useful in guiding the parent. The parent can also attribute a virtual allowance to the child user allotted if certain daily tasks (such as household chores) are performed. The parent may choose a reminder option, which sends the child a periodic reminder to accomplish certain tasks.

The Sharing Parameters Interface 260 provides the parent with tools to control the types of categories and organizations that appear as choices for the child to donate to. For example, the parent may want to emphasize humanitarian donations geared to hunger or disease rather than other charities and foundations and may want to make their child aware of certain social or environmental issues.

The Spending/Goal Parameters Interface 262 provides the parent with tools for configuring the spending and goal scenarios and events of the game. For example, the parent may wish to add or remove certain categories or specific products. The parent may wish to avoid that the child user purchase products in only one type of category. The parent may also wish to guide the child towards a greater number or Need purchases rather than Desire purchases.

The Banking and Investment Parameters Interface 264 provides the parent with statistics information which can also be provided by or in conjunction with interface 258. Furthermore, the parent is provided with tools in order to configure the virtual investment products available to the child. The parent may want to encourage socially and environmentally responsible investments rather than purely speculative profit driven investments. The parent may also want to provide other investment options such as purchasing a home for a cartoon character and paying a mortgage. A variety of events can be selected and configured in order to configure a suitable version for the child.

The Children's Network Parameters Interface 266 provides the parent with tools to configure the Network 10A described above. In this way, the parent may wish to avoid that the child participate in certain network communities or they may want to encourage them to participate in others. The parent may not wish that the child sell and buy products to and from other users or may want to limit the type of products or category of products. The parent may want to configure the type of trading the child is involved in on the Network Investment and Exchange Interface 208 or the type of charities, foundations and fundraisers available to the child. Of course the foregoing may be done in conjunction with the interfaces 260, 262 and 264.

In some jurisdictions it is strictly prohibited to advertise to children, in other jurisdictions advertisement to children is regulated but not prohibited and still others there are no regulations. An Advertisement Parameters Interface 268 allows a parent to monitor products or charities advertised to children within the context of the game as well as block any and all advertisement.

### Third Party Servers

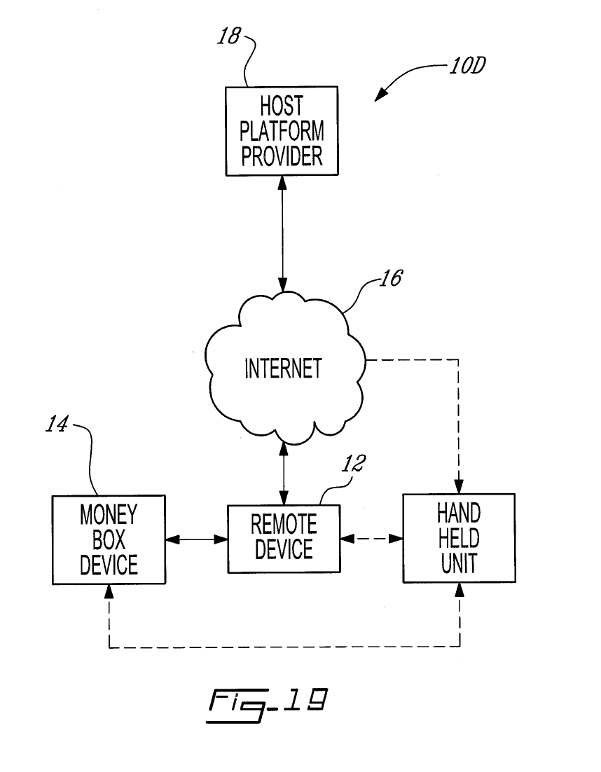

FIG. 18 shows a game environment 10C comprising the remote device 12 linked to the moneybox device 14 and to the host platform provider 1 via the internet 16.

A third party server 300 is linked to the host platform provider 18 for receiving and sending data thereto. The third party server 300 comprises a variety of marketing and/or advertising agencies. A given third party server 300 may be selected based on the identification code of the reader 20 as previously discussed. As such, when a user possesses a certain code the host platform provider 18 communicates or selects a given third party server based on that given code. The third party server 300 may therefore advertise products directly to the user or to the parents (as in environment 10B).

In one embodiment, the third party server 300 is provided with behavioral information. For example, when purchasing products, the user seems to select sports items more often. The third party server 300 can then advertise to the user or the parent different types of sports products.

In a further embodiment, when the reader 20 was purchased from a particular institution such as a bank, the third party server 300 identifies this from the identification code and can advertise various products to the parents from that institution. The same institution may also provide news or other relevant information or gifts.

In yet another embodiment, the third party server 300 does not have direct contact with the user or the parent, the host platform provider 18 provides the third party server 300 with marketing information related to the users (children and parents), the third party server 300 can then provide the host platform provide 18 with advertisements or other products that the host platform provider 18 will send directly to its adult and child users.

In another game environment, the moneybox device 14 is not used. In this case, parents via their interactive interface can choose to allot virtual money and/or points to the child user. In fact the moneybox can be a virtual moneybox.

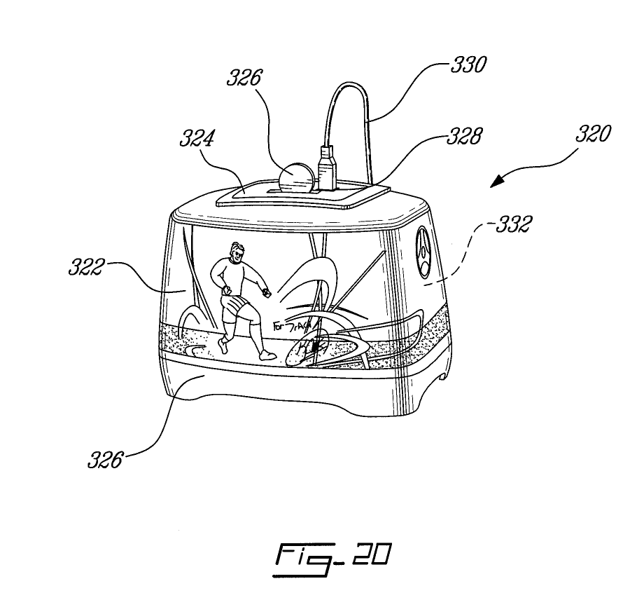

FIG. 19 shows a game environment 10D similar to game environment 10 with the difference that it includes a hand held unit 310. The hand held unit comprises an interface for providing the user with real time information regarding their money allocation scheme as provided herein. In this way, as the user is an actual store, they can access their budget and view if they have the financial means to make a certain purchase or reallocate their moneys accordingly in real time. Of course, this money may be virtual money and the hand held unit 310 acts as an educational tool for money management in real life scenarios. Thus, the hand held unit 310 which can be an i-phone, an i-pad, an i-pod, a cell phone, a blackberry, or any kind of similar device can be linked to the remote device 12, in another embodiment, the hand held unit 310 is the remote device 12 is directly communicates with the host platform provider 18 and the moneybox device 14.

FIG. 20 shows a money box 320 comprising a translucent main body 322 capped by top and bottom faces 324 and 326 respectively. The top face 324 includes a coin reader 326 and an output 328 to communicate with a remote device 12 via a wire 330. An insert 332 is viewable via the translucent main body 322. The user can select via the interface device 12 a variety of insert designs which are communicated to the host platform provider 18 and then transmitted to the user via mail or electronically via the internet.

Therefore a variety of applications are provided by the game environments, systems, networks and devices disclosed herein.

For example, the game environments, systems, networks and devices disclosed herein provide advertisers to communicate with parents based on their child's behavior within an interactive virtual money management game and advise them about financial literacy issues based on social networking, blogs, as well as expert live exchanges.

Teachers can use the tools provided herein in the classroom to promote financial literacy with an educational and interactive moneybox connected to a multi-student platform to create fundraising projects and virtual allowances based on school tasks and the like. The present disclosure allows for social networking thereby raising money for personal projects such as a foundation, a personal objective, studies with automatic event-based fundraising. The games disclosed herein provide for joining coins collection with a specific personalized moneybox and augmented reality.

It should be noted that the various game environments can be fully or partially combined in a variety of ways so as to provide other game environments within the scope of the invention.

It should be noted that the various components and features described above can be combined in a variety of ways so as to provide other non-illustrated embodiments within the scope of the invention.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of embodiments thereof, it can be modified, without departing from the spirit, scope and nature of the subject invention.

1. A system for an educational money management game using the Internet comprising:
a host platform provider for providing the money management game;
at least one remote interface device in communication with said host platform provider, said interface device displaying interactive game scenes produced by said host platform provider to a user; and
a moneybox in communication with said interface device and comprising a reader for reading the monetary value of coins inserted therein,
wherein when the user inserts coins in said moneybox, the monetary value thereof is communicated to said host platform provider and displayed by said interface device to be viewed by the user.

2. A system according to claim 1, wherein the money management game comprises providing the user with the option of allotting at least portions of the monetary value to predetermined money allocation options, said host platform provider providing for different money allocation options to be displayed via said interface device to the user, said interface display device providing the user with communicating said allocation options.

3. (canceled)

4. A system according to any one of claim 1, wherein said moneybox communicates to said host platform provider the total value of coins therein.

5. A system according to claim 1, wherein said interface device provides the user with communicating an amount of non-coin funds, said host server providing for adding the value of amount of non-coin funds to the previously communicated monetary value of inserted coins.

6. A system according to claim 1, wherein said host server provides for displaying an allocation interactive scene providing the user to allocate portions of the monetary value into different sections, wherein said different sections are selected from the group consisting of at least one spend section, at least one save section, at least one invest section, at least one share section, at least one goal section and any combination thereof.

7-10. (canceled)

11. A system according to claim 6, wherein said interface device provides for communicating to said host platform provider that a desired portion of the monetary value be allotted to a given said section.

12. A system according to claim 6, wherein said host platform provider provides pre-determined ratios of the monetary value to be allotted to given said sections, wherein said interface device provides for communicating to said host platform provider a desired modification of said pre-determined ratios.

13. (canceled)

14. A system according to claim 6, wherein said goal section comprises a predetermined monetary value to be progressively allotted thereto by the user, said host provider produces a progress message displayed by said interface device indicating the amount of money allotted to the goal section and the amount of money left to allot so as to reach said predetermined monetary value.

15-16. (canceled)

17. A system according to claim 1, wherein said host platform provider produces cartoon images of the types of coins read by said moneybox reader to be displayed by said interface device.

18. A system according to claim 5, wherein said host platform provider produces cartoon images of the types of non-coin funds communicated via said interface device.

19. A system according to claim 1, wherein said host platform provider attributes virtual money in relation to communication entries provided by the user via said interface device, said system further comprising an additional interface device in communication with said host platform provider, wherein said virtual monetary units are produced by said host platform provider in response to entries communicated via said additional interface device.

20-21. (canceled)

22. A system according to claim 1, further comprising an additional interface device providing for communicating with said host platform provider so as to modulate the interactive game scenes produced by said host platform provider.

23. A system according to claim 1, further comprising a plurality of remote devices in communication with said host platform provider for a corresponding plurality of users, wherein said host platform provider produces a common interactive image displayed by each said remote interface device, wherein said common interactive image provides for displaying an aggregate value of money corresponding to the total value of at least a portion of said monetary value displayed by each said remote interface device to each user.

24-25. (canceled)

26. A system according to claim 1, wherein said moneybox comprises an identification code communicated to said host platform provider when linked to said interface device, said system further comprising a third party server in communication with said host platform provider, said third party server communicating information to the user via said interface device in response to said identification code.

27. A system according to claim 26, wherein said host platform provider modulates said interactive game scenes in response to said identification code.

28. (canceled)

29. A system according to claim 26, wherein said third party server modulates the information sent to said host platform provider to be displayed via said interface device in accordance with said allocation options communicated by the user.

30. A system according to claim 26, wherein said host platform provider modulates transmission to said interface device of the information received from said third party server to in accordance with said allocation options communicated by the user.

31. (canceled)

32. A system according to claim 1, wherein said moneybox comprises an identification code communicated to said host platform provider when linked to said interface device, said moneybox reader comprising said identification code.

33. A system according to claim 1, further comprising a hand held unit comprising an additional interface.

34-35. (canceled)

36. A system according to claim 1, wherein said reader is removable mountable to a variety of moneyboxes.

37. A system according to claim 1, wherein said moneybox comprises transparent material, said host platform provider providing the user with a variety of moneybox-insert designs to select from displayed via said interface device.

38. An educational money management video game for at least one user comprising:
a moneybox for providing the user to insert coins therein and comprising a reader for reading the monetary value of inserted coins; and
an interface for displaying interactive scenes to the user, said interface communicating with said moneybox so as to display the monetary value of the coins therein, said interface displaying different money allocation options wherein said interface provides for the user to allot at least a portion of said displayed monetary value to one or more of said allocation options.

39. A video game according to claim 38, wherein said allocation options comprise different section images displayed by said interface, wherein said different section images comprise at least one share section image, wherein said at least one share section image comprises a plurality of charity images for the user to select from.

40-57. (canceled)

58. A video game according claim 38, wherein said interface provides the user with communicating an amount of non-coin funds, said video game further comprising a behavior monitor for monitoring the economic behavior of the user, said economic behavior of the user comprising said allotment options selected by the user and the portions of said monetary value allotted to each said allotment option, wherein said behavior monitor attributes a score based on said economic behavior.

59. A video game according to claim 58, wherein said behavior monitor attributes virtual money based on said economic behavior.

60. A video game according claim 38, wherein said interface provides the user with communicating an amount of non-coin funds, said video game further comprising a behavior monitor for monitoring the economic behavior of the user, said economic behavior of the user comprising said allocation options selected by the user and the portions of said monetary value allotted to each said allocation option, wherein said behavior monitor comprises a plurality of parameters for attributing a given said score to a given said economic behavior.

61. A video game according to claim 58, wherein said behavior monitor comprises a plurality of parameters for attributing a given amount of said virtual money to a given said economic behavior, wherein said interface allows the user to modulate said plurality of parameters.

62. A video game according to claim 60, wherein said interface allows the user to modulate said plurality of parameters.

63. An educational money management video game network for a plurality of remote users, said video game network comprising:
a host platform provider; and
a plurality of remote interfaces in communication with said host platform provider, each said interface associated to a respective remoter user for displaying interactive game scenes produced by said host platform provider to the respective user, said game scenes comprising a common image displayed by each one of said plurality of remote interfaces; and
a plurality of moneyboxes, each one of said moneyboxes associated with a respective remote given user and being in communication with said interface associated with the respective user, each said moneybox comprising a reader for reading the monetary value of coins inserted therein,wherein each said interface provides for each user to allot at least a portion of said displayed monetary value to said common image, said common image displaying an aggregate value of money corresponding to the total value of each said at least a portion of said monetary value.
